(19) United States
(12) Patent Application Publication
(10) Pub. No.: US 2025/0231697 A1
(43) Pub. Date: Jul. 17, 2025

(54) Memory access circuit and method having secure access mechanism

(71) Applicant: REALTEK SEMICONDUCTOR CORPORATION, HSINCHU (TW)

(72) Inventors: YUNG-HUI YU, HSINCHU (TW); WEI-JUI CHENG, HSINCHU (TW)

(21) Appl. No.: 19/003,225

(22) Filed: Dec. 27, 2024

(30) Foreign Application Priority Data
Jan. 16, 2024 (TW) 113101774

(51) Int. Cl. G06F 3/06; G06F 12/02

(52) U.S. Cl. CPC G06F 3/0622; G06F 3/0637; G06F 3/0679; G06F 12/0246; G06F 2212/7201

(57) ABSTRACT

The present invention discloses a memory access circuit. A command translation circuit translates an access command from a processor to generate access address information matching an encryption/decryption addressing of memory blocks. An address block check circuit determines a security mode according to the access address information to generate mode information. An address generation circuit generates an access block address according to the access address information and the mode information. A command generation circuit generates an actual the access command according to the access block address. An access processing circuit receives an accessed content from a flash memory corresponding to the access block address to perform security processing on the accessed content according to the security mode and the access block address and subsequently perform data recovery according to a data access order of the access command to generate buffered access data to be accessed by the processor.

### BACKGROUND OF THE INVENTION

### 1. Field of the Invention

The present invention relates to a memory access circuit and a memory access method having secure access mechanism.

### 2. Description of Related Art

In security applications, verification on programs executed by a processor is required to make sure that these programs are legal instead of malicious software. Further, verification on these programs to make sure that no modification is performed thereto is also required. The correctness of the system function can therefore be guaranteed and the invasion of the malicious software can be avoided. Moreover, the programs or data stored in a flash memory may be the assets of the manufacturer of the devices that include the flash memory, in which the program or data can be classified and stored with encryption. The programs and the data are loaded to the chip and decrypted before the execution of the programs such that the processor executes the decrypted programs based on the decrypted data.

However, the image file of the whole procedures in the program or the whole data is required to be loaded to the memory in the chip to be decrypted or verified to guarantee the security thereof by the processor. Such a design increases the cost of the chip and can not accomplish the application of execute in place (XiP).

### SUMMARY OF THE INVENTION

In consideration of the problem of the prior art, an object of the present invention is to supply a memory access circuit and a memory access method having secure access mechanism.

The present invention discloses a memory access circuit having a secure access mechanism configured to access a flash memory, wherein the flash memory includes a plurality of memory blocks categorized into a plurality of memory areas each configured to have a security mode. The memory access circuit includes a command translation circuit, an address block check circuit, an address generation circuit, a command generation circuit and an access processing circuit. The command translation circuit is configured to receive and translate an access command from a processor to generate access address information matching an encryption and decryption addressing of the memory blocks. The address block check circuit is configured to, according to the access address information, determine the security mode corresponding thereto to generate mode information. The address generation circuit is configured to generate an access block address according to the access address information and the mode information. The command generation circuit is configured to generate an actual access command for accessing the flash memory according to the access block address. The access processing circuit is configured to receive an accessed content corresponding to the access block address from the flash memory to perform a security processing on the accessed content according to the mode information and the access block address and perform a data recovery according to a data access order of the access command to generate and store access data to be accessed by the processor.

The present invention also discloses a memory access method having a secure access mechanism used in a memory access circuit configured to access a flash memory, wherein the flash memory includes a plurality of memory blocks categorized into a plurality of memory areas each configured to have a security mode. The memory access method includes steps outlined below. An access command is received and translated from a processor by a command translation circuit to generate access address information matching an encryption and decryption addressing of the memory blocks. According to the access address information, the security mode corresponding thereto is determined by an address block check circuit to generate mode information. An access block address is generated according to the access address information and the mode information by an address generation circuit. An actual access command for accessing the flash memory is generated according to the access block address by a command generation circuit. An accessed content corresponding to the access block address is received from the flash memory by an access processing circuit to perform a security processing on the accessed content according to the mode information and the access block address and perform a data recovery according to a data access order of the access command to generate and store access data to be accessed by the processor.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of an electronic apparatus according to an embodiment of the present invention.

FIG. 2 illustrates a diagram of the flash memory according to an embodiment of the present invention.

FIG. 3 illustrates a block diagram of the memory access circuit according to an embodiment of the present invention.

FIG. 4A to FIG. 4D respectively illustrates an address table according to an embodiment of the present invention.

FIG. 5 illustrates a diagram of the encryption and decryption information according to an embodiment of the present invention.

FIG. 6A to FIG. 6D respectively illustrates an address table according to an embodiment of the present invention.

FIG. 7 illustrates the memory area in FIG. 2 according to another embodiment of the present invention.

FIG. 8 illustrates a flow chart of a memory access method according to an embodiment of the present invention.

### DETAILED DESCRIPTION OF THE PREFERRED EMBODIMENTS

An aspect of the present invention is to provide a memory access circuit and a memory access method having secure access mechanism to respectively perform processing on memory areas in a flash memory having different security modes and perform security processing on respectively memory blocks in the flash memory without loading the whole image file. The memory access circuit can thus decrease the cost of the security processing and accomplish the XiP application for the system-on-a-chip (SoC) that the memory access circuit resides.

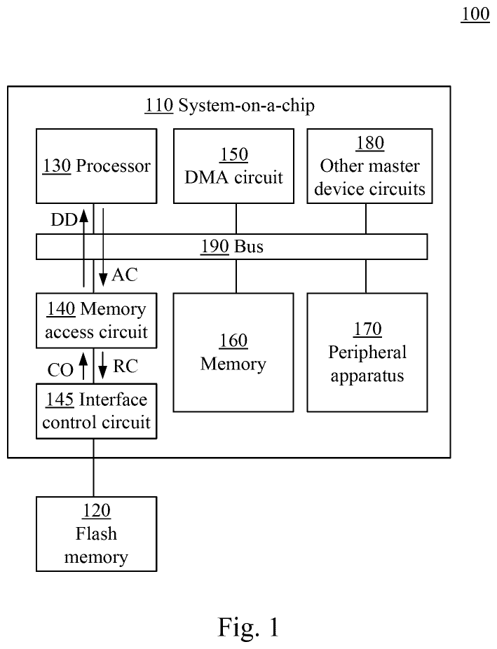

Reference is now made to FIG. 1. FIG. 1 illustrates a block diagram of an electronic system 100 according to an embodiment of the present invention. In an embodiment, the electronic system 100 includes a system-on-a-chip 110 and a flash memory 120.

The system-on-a-chip 110 can be a chip of such as, but not limited to an Internet of Things (IOT) apparatus. The flash memory 120 is configured to store data to be accessed by the system-on-a-chip 110. It is appreciated that the data stored by the flash memory 120 can be firmware, an application program or pure data.

The system-on-a-chip 110 includes a processor 130 and a memory access circuit 140. The processor 130 is configured to transmit an access command AC to be processed by the memory access circuit 140 to generate an actual access command RC to further access the flash memory 120 according to the actual access command RC. The memory access circuit 140 receives and processes an accessed content CO from the flash memory 120 to generate an access data DD to be retrieved by the processor 130.

In an embodiment, the system-on-a-chip 110 includes an interface control circuit 145 disposed between the memory access circuit 140 and the flash memory 120 to perform conversion of the format of such as, but not limited to serial peripheral interface (SPI) on the data between the memory access circuit 140 and the flash memory 120. However, the present invention is not limited thereto.

In an embodiment, the system-on-a-chip 110 may further include such as, but not limited to a direct memory access (DMA) circuit 150, a memory 160 including a static random access memory (SRAM) and/or a read-only memory (ROM), a peripheral apparatus 170 and other master device circuits 180 that operate under the control of the processor 130. The components included in the system-on-a-chip 110 described above may perform communication through the bus 190 further included by the system-on-a-chip 110.

It is appreciated that the components included by the system-on-a-chip 110 described above are merely an example. The present invention is not limited thereto.

In order to guarantee the correctness of the system function and avoid the invasion of malicious software when the processor 130 accesses the flash memory 120, the memory access circuit 140 provides a secured access mechanism such that the processor 130 accesses the flash memory 120 with high security.

The configuration and operation of the flash memory 120 and the memory access circuit 140 are described in detail in the following paragraphs.

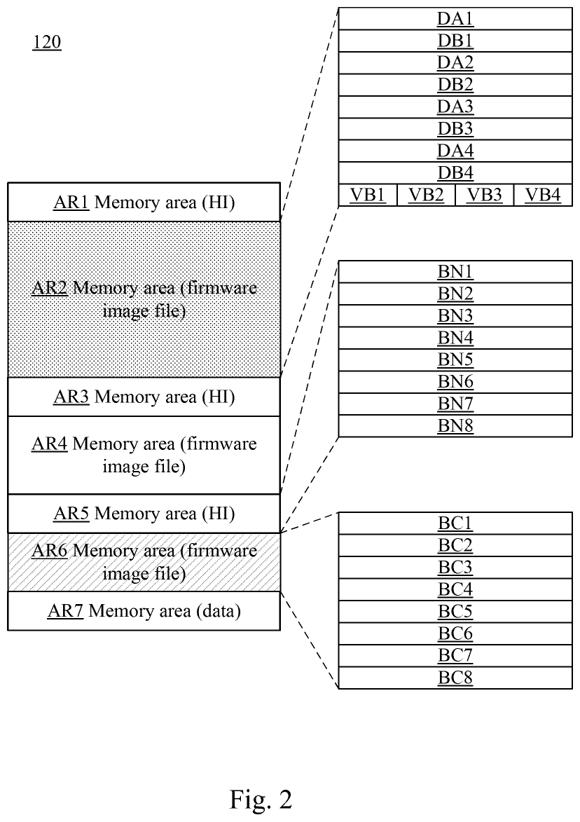

Reference is now made to FIG. 2. FIG. 2 illustrates a diagram of the flash memory 120 according to an embodiment of the present invention.

The flash memory 120 includes a plurality of memory blocks categorized into a plurality of memory areas AR1˜AR7. In FIG. 2, the memory areas AR2, AR5 and AR6 are exemplarily enlarged to illustrate the memory blocks therein. Each of the memory areas AR1˜AR7 is configured to have a security mode such that the memory blocks stores data and are accessed according to the security mode of the memory area that the memory blocks reside.

In an embodiment, the security modes include such as, but not limited to a non-encrypted and non-verification mode, an encryption mode, a verification mode and an encrypted and verification mode.

The data corresponding to the memory areas having the non-encrypted and non-verification mode is not encrypted and does not have corresponding verification information. As a result, the data corresponding to the memory areas having the non-encrypted and non-verification mode, when being read, neither needs to be decrypted nor needs the performance of the integrity verification. In the example in FIG. 2, the memory areas AR1, AR3 and AR5 configured to store header information (abbreviated as HI in FIG. 2), the memory area AR4 configured to store a firmware image file and the memory area AR7 configured to store other data are further configured to have the non-encrypted and non-verification mode and are illustrated as blanked areas. Take the memory area AR5 as an example, memory blocks BN1˜BN8 are included therein and these memory blocks are all data blocks.

The data corresponding to the memory areas having the encryption mode is encrypted by such as, but not limited to a block cipher method and does not have the corresponding verification information. As a result, the data corresponding to the memory areas having the encryption mode, when being read, needs to be decrypted but does not need the performance of the integrity verification. In the example in FIG. 2, the memory area AR6 configured to store a firmware image file is configured to have the encryption mode and is illustrated as a slashed area. The memory area AR6 includes memory blocks BC1˜BC8 and theses memory blocks are all encrypted data blocks.

When the AES encryption technology is used, the encryption can be performed on a block size of a certain number of bits such that the data amount encrypted once equals to the certain number of bits. In a numerical example, the size of a memory block corresponding to the AES encryption technology is 128 bits. The encryption and decryption can selectively use the data amount of a single memory block or the data amount of a plurality of memory blocks (e.g., 2˜4) as an encryption and decryption block. For example, if the encryption and decryption uses the data amount of two memory blocks as an encryption and decryption block, the size of the encryption and decryption block is 32 bytes.

The AES encryption technology may include different modes. In an embodiment, the encryption may use the AES-CTR mode that hides the encryption time to lower the delay, such that a data scrambling is performed with the use of the encryption and decryption information to further store the data. It is appreciated that the AES encryption technology and the corresponding mode described above are merely an example. In different embodiments, the flash memory 120 may perform encryption according to different encryption technologies and modes.

The data corresponding to the memory areas having the verification mode is not encrypted but includes the corresponding verification information. As a result, the data corresponding to the memory areas having the verification mode, when being read, does not need to be decrypted but needs the performance of the integrity verification. The data corresponding to the memory areas having the encrypted and verification mode are encrypted by using the encryption method described above and also includes the verification information. As a result, the data corresponding to the memory areas having the encrypted and verification mode, when being read, needs to be decrypted and also needs the performance of the integrity verification. In the example in FIG. 2, the memory area AR2 configured to store a firmware image file is configured to have the encrypted and verification mode and is illustrated as a dotted area.

Since the difference between the memory areas configured to have the verification mode and the encrypted and verification mode is that whether the memory blocks in these memory areas are encrypted or not, the example in FIG. 2 does not additional illustrate the memory areas configured to have the verification mode. The memory area AR2 configured to have the encrypted and verification mode is used to describe the operation thereof.

In the present embodiment, the memory blocks included by the memory area AR2 are data blocks DA1˜DA4 and DB1˜DB4 and verification information blocks VB1˜VB4 disposed independently. The data blocks DA1˜DA4, DB1˜DB4 is configured to store the data content. The verification information blocks VB1˜VB4 is configured to store the verification information content used to verify the data blocks DA1˜DA4 and DB1˜DB4, such as but not limited to a message authentication code (MAC) or a tag.

In different embodiments, the size of the verification information blocks VB1˜VB4 is set to be such as, but not limited to 32 bits, 64 bits, 128 bits or other sizes, depending on different security strength requirements, different occupied memory spaces and different verification times. The smaller size of the verification information blocks VB1˜VB4 results in lower security strength but with lesser occupied memory space.

The verification information content of each of the verification information blocks VB1˜VB4 is generated corresponding to an encryption and decryption block, wherein an encryption and decryption block, as described above, includes one or more than one memory blocks. In the present embodiment, the verification information content of each of the verification information blocks VB1˜VB4 is generated base on the calculation performed on 2 data blocks and is used to verify the corresponding 2 data blocks.

More specifically, the verification information content of the verification information block VB1 is generated corresponding to the data blocks DA1 and DB1 to verify the data blocks DA1 and DB1. The verification information content of the verification information block VB2 is generated corresponding to the data blocks DA2 and DB2 to verify the data blocks DA2 and DB2. The verification information content of the verification information block VB3 is generated corresponding to data blocks DA3 and DB3 to verify the data blocks DA3 and DB3. The verification information content of the verification information block VB4 is generated corresponding to the data blocks DA4 and DB4 to verify the data blocks DA4 and DB4.

It is appreciated that, the corresponding relation described above is merely an example. In other embodiments, the verification information content of the verification information block can be generated based on the calculation performed on the encryption and decryption block including 2N data blocks, N being an integer larger than or equaling to 0. The present invention is not limited thereto.

In an embodiment, the generation of the verification information content described above and the verification method can be accomplished by using such as, but not limited to Galois/counter Mode (GCM) in the AES encryption technology. However, in different embodiments, the flash memory 120 may use other verification technologies in combination with the encryption technologies. The present invention is not limited thereto.

The embodiment described above uses the encrypted and verification mode combining the encryption technology and the verification technology as an example. For the memory areas that are configured to only have the verification mode, data blocks not encrypted are included and verification information blocks corresponding to these data blocks are also included. The configuration of these verification information blocks is identical to the configuration of the verification information blocks corresponding to the encrypted data blocks described above. As a result, the detail is not described herein.

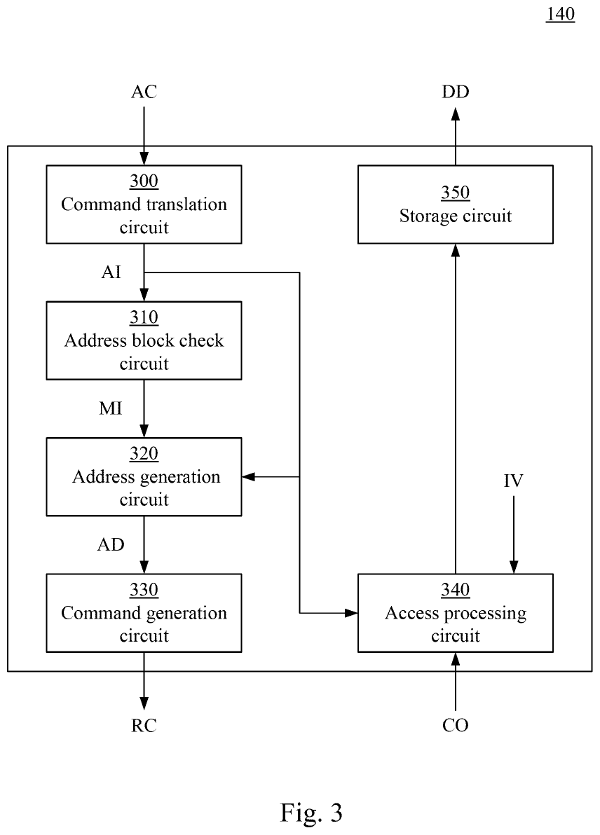

Reference is now made to FIG. 3. FIG. 3 illustrates a block diagram of the memory access circuit 140 according to an embodiment of the present invention. The memory access circuit 140 includes a command translation circuit 300, an address block check circuit 310, an address generation circuit 320, a command generation circuit 330, an access processing circuit 340 and a storage circuit 350.

The command translation circuit 300 receives and translates the access command AC from the processor 130 in FIG. 1 to generate access address information AI matching an encryption and decryption addressing of the memory blocks.

More specifically, since the flash memory 120 stores the data with the block cipher method, the addresses to be accessed by the access command AC from the processor 130 may start from any initial address and the length thereof may not align to the addressing of the encryption and decryption block. As a result, the command translation circuit 300 converts the initial address and the access range requested by the access command AC to align the address of the encryption and decryption block of the flash memory 120 to generate the access address information AI.

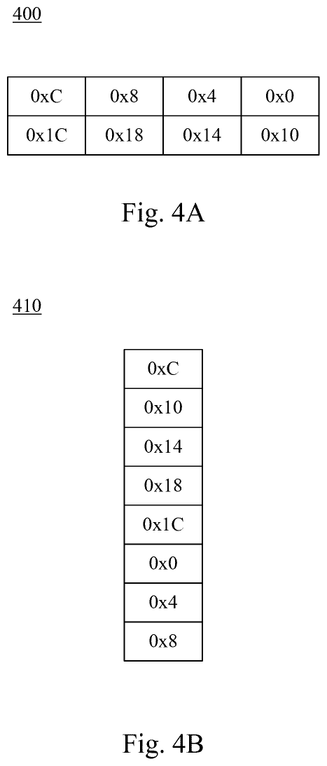

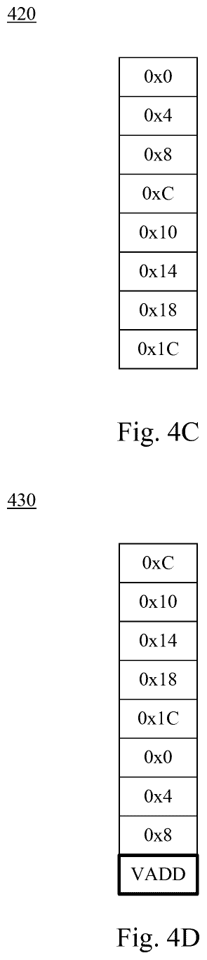

Reference is now made to FIG. 4A to FIG. 4D. FIG. 4A to FIG. 4D respectively illustrates an address table according to an embodiment of the present invention. The address table in each of FIG. 4A to FIG. 4D is related to the access command AC and the access address information AI.

In an embodiment, the access command AC is a wrap burst command to perform burst mode data access corresponding to a plurality of addresses from an initial address according to the wrap of the addresses.

Take the address table 400 in FIG. 4A as an example, the address table 400 includes two rows of addresses. The first row of addresses are 0×c, 0×8, 0×4 and 0×0, and the second row of addresses are 0×1c, 0×18, 0×14 and 0×10. These two rows of addresses correspond to an encryption and decryption block.

Corresponding to the data access method of the wrap burst command, the data access order that the processor 130 in FIG. 1 actually requests includes an initial address of Oxc, and the data is read from the last address of the address table 400 in a reverse direction. As a result, as illustrated in the address table 410 in FIG. 4B, the data access order that the access command AC actually requires is 0×c, 0×10, 0×14, 0×18, 0×1c, 0×0, 0×4 and 0×8.

The command translation circuit 300 rearranges the data access order to align with the addresses of the encryption and decryption block in the flash memory 120. As illustrated in the address table 420 in FIG. 4C, the actual read order that is already rearranged included in the access address information AI is 0×0, 0×4, 0×8, 0×c, 0×10, 0×14, 0×18, 0×1c.

The address block check circuit 310 determines the corresponding security mode according to the access address information AI to generate the mode information MI.

More specifically, the address block check circuit 310 determines the memory area that the memory blocks that the address range to be accessed belong to according to the access address information AI, so as to further determine the security mode of the memory area to generate the mode information MI.

For example, when the memory blocks to be accessed is determined to belong to the memory area AR4, the address block check circuit 310 generates the mode information MI indicating that the security mode is the non-encrypted and non-verification mode. When the memory blocks to be accessed is determined to belong to the memory area AR6, the address block check circuit 310 generates the mode information MI indicating that the security mode is the encryption mode. When the memory blocks to be accessed is determined to belong to the memory area AR2, the address block check circuit 310 generates the mode information MI indicating that the security mode is the encrypted and verification mode.

The address generation circuit 320 generates an access block address AD according to the access address information AI and the mode information MI. The operation of the address generation circuit 320 is described based on the conditions of different security modes in the following paragraph.

When the mode information MI indicates that the security mode is the non-encrypted and non-verification mode or the encryption mode, the memory blocks to be read (e.g., the memory blocks BN1˜BN8 in the memory area AR5 having the non-encrypted and non-verification mode or the memory blocks BC1˜BC8 in the memory area AR6 having the encryption mode) does not need to perform verification thereon.

Under such a condition, the address generation circuit 320 directly configures the access block address AD to only correspond to the address in the access address information AI. The access block address AD includes the block addresses 0x0, 0x4, 0x8, 0xc, 0x10, 0x14, 0x18, 0x1c in the order shown in the address table 420 in FIG. 4C.

When the mode information MI indicates that the security mode is the encrypted and verification mode, the memory blocks to be read include the data blocks and the verification information blocks (e.g., the data blocks DA1˜DA4 and DB1˜DB4 and the verification information blocks VB1˜VB4 in FIG. 2) such that the verification is performed on the data blocks according to the verification information content stored in the verification information blocks.

Under such a condition, besides finding out that the security mode is the encrypted and verification mode according to the mode information MI and obtaining the data block address of the data blocks according to the access address information AI, the address generation circuit 320 further needs to calculate and generate the verification information block address of the verification information blocks according to data block address such that the access block address AD includes the data block address and the verification information block address.

The access block address AD includes, as illustrated in the address table 430 in FIG. 4D, not only the data block address in the order of 0×0, 0×4, 0×8, 0×c, 0×10, 0x14, 0x18, 0x1c in the address table 420, but also the verification information block address VADD illustrated with a thick frame.

In an embodiment, when the memory area corresponding to the encrypted and verification mode has the configuration as the memory area AR2 in FIG. 2, the address generation circuit 320 may record an initial address of all the verification information blocks VB1˜VB4 (which is the initial address of the verification information block VB1 in the embodiment in FIG. 2). The address generation circuit 320 further calculates an offset according to the position of the data blocks to be accessed related to all the data blocks and the size of the verification information blocks, in which the offset is added to the initial address to generate the verification information block address that is actually accessed.

For example, when the data blocks DA3 and DB3 in FIG. 2 are accessed and the size of each of the verification information block is 32 bits, the address generation circuit 320 finds out that the third verification information block VB3 is to be accessed according to the position of the data blocks DA3 and DB3. The address generation circuit 320 adds the offset of 32×3=96 to the initial address of all the verification information blocks (i.e., the initial address of the verification information block VB1) to obtain the verification information block address that is actually accessed.

The memory blocks may include the data blocks DA1˜DA4 and DB1˜DB4 and the verification information blocks VB1˜VB4 disposed independently. The data blocks DA1˜DA4 and DB1˜DB4 are configured to store the data content. The verification information blocks VB1˜VB4 are configured to store the verification information content used to verify the data blocks DA1˜DA4 and DB1˜DB4.

The command generation circuit 330 is configured to generate the actual access command RC for accessing the flash memory 120 according to the access block address AD. In an embodiment, the command generation circuit 330 transmits the actual access command RC through the interface control circuit 145 configured to perform format conversion in FIG. 1 to the flash memory 120 in FIG. 1 to access the flash memory 120.

The access processing circuit 340 receives the accessed content CO corresponding to the access block address AD from the flash memory 120. In an embodiment, the access processing circuit 340 receives the accessed content CO from the flash memory 120 through the interface control circuit 145 configured to perform format conversion in FIG. 1 to the flash memory 120 in FIG. 1.

The access processing circuit 340 performs a security processing on the accessed content CO according to the mode information MI and the access block address AD. The operation of the access processing circuit 340 is described based on the conditions of different security modes in the following paragraph.

When the mode information MI indicates that the security mode is the non-encrypted and non-verification mode, the access processing circuit 340 perform the security processing that includes a bypass process on the accessed content CO without performing any actual processing thereon.

When the mode information MI indicates that the security mode is the encryption mode, the access processing circuit 340 performs the security processing that includes the decryption process on the accessed content CO, in which the decryption process is configured to decrypt the accessed content CO according to encryption and decryption information IV related to the access block address AD.

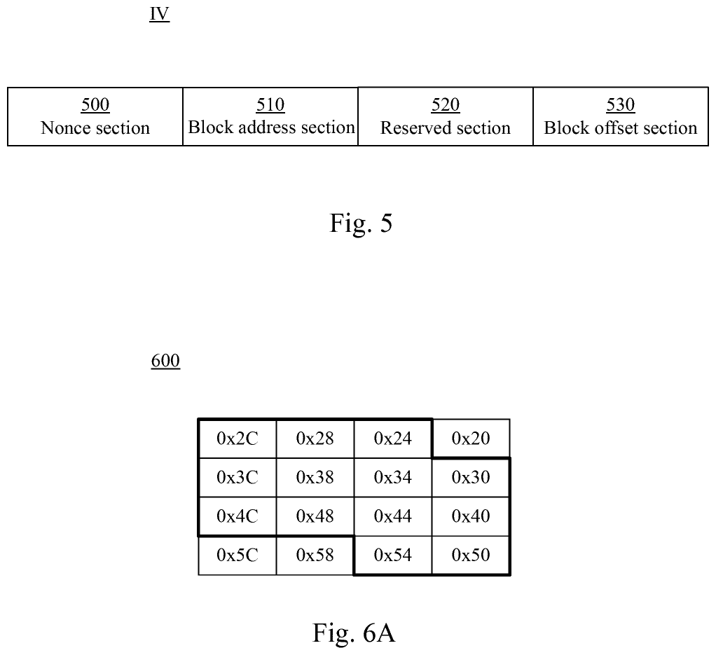

Reference is now made to FIG. 5. FIG. 5 illustrates a diagram of the encryption and decryption information IV according to an embodiment of the present invention.

In an embodiment, the encryption and decryption information IV includes (or is) an initial vector (IV). The initial vector includes a nonce section 500, a block address section 510, a reserved section 520, a block offset section 530 or a combination thereof. In a numerical example, the nonce section 500 has a length of 64 bits, the block address section 510 has a length of 32 bits, the reserved section 520 has a length of 28 bits and the block offset section 530 has a length of 4 bits.

Different values may be set to the nonce section 500 according to different memory areas, and the values may be generated according to such as, but not limited to a firmware version, a image file number, a chip identification number, a random value or a combination thereof. The block address section 510 may correspond to addresses of different memory blocks. In an embodiment, when the size of the encryption and decryption block (including one or more than one memory blocks) is BS, and the access address included by the access command AC from the processor 130 in FIG. 1 is INA, the content of the block address section 510 can be generated by an equation of INA>>(4+log2(BS/16)).

The reserved section 520 may be set to 0 in a default condition, or may be set to other values in specific conditions. The block offset section 530 is the offset of the memory blocks in an encryption and decryption block relative to an initial address of such an encryption and decryption block.

Take the encryption and decryption block having a size of 32 bytes and the nonce section 500 is set to be 0×7654321089abcdef as an example, when the access address INA included in the access command AC is 0×0800_1220, the encryption and decryption information IV is 0×76543210_89abcdef_00400091_00000001. When the access address INA is 0×0800_1230, the encryption and decryption information IV is 0×76543210_89abcdef_00400091_00000002. When the access address INA is 0×0800_1240, the encryption and decryption information IV is 0×76543210_89abcdef 00400092_00000001.

In an embodiment, the data can be encrypted by performing such as, but not limited to an XOR logic operation according to the encryption and decryption information IV so as to be stored in the memory blocks. Therefore, corresponding to the encryption mode, the access processing circuit 340 may look up the nonce section 500 set corresponding to the access block address AD and calculate the block address section 510 and the block offset section 530 according to the access block address AD to obtain the encryption and decryption information IV. Moreover, the access processing circuit 340 performs encryption calculation (e.g., AES encryption calculation) on the accessed content CO and the encryption and decryption information IV and subsequently performs such as, but not limited to the XOR logic operation on the calculation result and the accessed content CO to perform decryption to finish the security processing that includes the decryption process.

When the mode information MI indicates that the security mode is the encrypted and verification mode, besides the decryption process, the access processing circuit 340 further performs the security processing including the verification process on the accessed content CO.

Take the memory area AR2 in FIG. 2 as an example, when the memory area AR2 having the encrypted and verification mode is accessed, the accessed content CO received by the access processing circuit 340 includes the data content of the data blocks (e.g., the data blocks DA1 and DB1) and the verification information content of the verification information block (e.g., verification information block VB1). As a result, the access processing circuit 340 may perform verification on the data content according to the verification information content to finish the security processing that includes the verification process.

After finishing the security processing, the access processing circuit 340 performs data recovery according to the data access order of the access command AC to generate the access data DD. More specifically, after the security processing is performed on the accessed content CO, the data having the address order illustrated in the address table 420 in FIG. 4C is generated. The access processing circuit 340 further performs the data recovery to generate the data having the data access order in the address table 410 in FIG. 4B.

The storage circuit 350 is configured to store the access data DD to be accessed by the processor 130. In an embodiment, the storage circuit 350 simultaneously stores the verification state of the access data DD such that the processor 130 accesses the access data DD when the verification state indicates a verified state.

In an embodiment, the storage circuit 350 also stores the data address of the access data DD. When the access address information generated by the translation of the command translation circuit 300 performed according to a subsequent access command from the processor 130 corresponds to the data address and verification state indicates the verified state, the access data DD in the storage circuit 350 may be directly accessed by the processor 130 without the whole accessing process of the flash memory 120 described above.

In some approaches, the processor needs to load the image file of the whole procedure or data into the memory in the chip to perform decryption or verification to guarantee the security, in which such a design increases the cost of the chip and can not accomplish the application of XiP.

The memory access circuit of the present invention respectively performs processing on memory areas in a flash memory having different security modes and performs security processing on respectively memory blocks in the flash memory without loading the whole image file. The memory access circuit can thus decrease the cost of the security processing and accomplish the XiP application for the system-on-a-chip that the memory access circuit resides.

It is appreciated that the access method of the memory access circuit 140 performed on the memory blocks described above is merely an example. In other embodiments, the memory access circuit 140 may perform different access method according to different access commands and different configurations of the memory blocks in the flash memory 120.

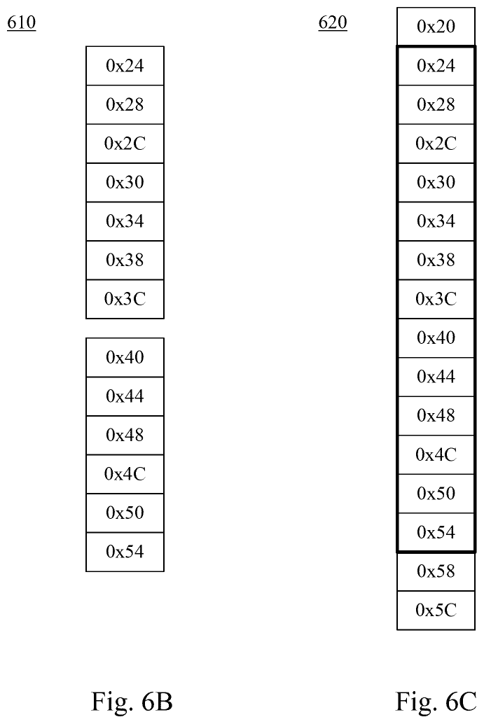

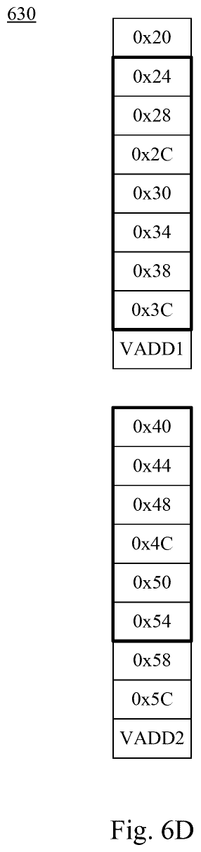

Reference is now made to FIG. 6A to FIG. 6D. FIG. 6A to FIG. 6D respectively illustrates an address table according to an embodiment of the present invention. The address table in each of FIG. 6A to FIG. 6D is related to the access command AC and the access address information AI.

In an embodiment, the access command AC generated by the processor 130 in FIG. 1 is an increment (INCR) burst command, in which the address range that is read thereby covers two encryption and decryption blocks.

Take the address table 600 in FIG. 6A as an example, the address table 600 includes four rows of addresses. The first row of addresses are 0x2c, 0×28, 0×24 and 0×20. The second row of addresses are 0×3c, 0×38, 0×34 and 0×30. The third row of addresses are 0×4c, 0×48, 0×44 and 0×40. The fourth row of addresses are 0×5c, 0×58, 0×54 and 0×50. The addresses of the first two rows correspond to an encryption and decryption block, and the addresses of the subsequent two rows correspond to another encryption and decryption block.

In the present embodiment, the data access order that the processor 130 in FIG. 1 actually requests includes an initial address of 0×24, and the data is read therefrom until the address 0×54, in which such a range is illustrated in a thick frame in FIG. 6A. As a result, as illustrated in the address table 610 in FIG. 6B, the data access order that the access command AC actually requests is 0×24, 0×28, 0×2c, 0×30, 0×34, 0×38, 0×3c, 0×40, 0×44, 0×48, 0×4c, 0×50 and 0×54.

The command translation circuit 300 in FIG. 3 rearranges the data access order to align with the addresses of the encryption and decryption block in the flash memory 120. As illustrated in the address table 620 in FIG. 6C, the actual read order that is already rearranged included in the access address information AI is 0×20, 0×24, 0×28, 0×2c, 0×30, 0×34, 0×38, 0×3c, 0×40, 0×44, 0×48, 0×4c, 0×50, 0×54, 0×58 and 0×5c to access the whole two encryption and decryption blocks. The actual address range requested by the processor 130 is also illustrated in a thick frame in FIG. 6C.

However, if the memory area that the memory blocks of these addresses correspond to is configured to have the encrypted and verification mode, as illustrated in the address table 630 in FIG. 6D, for the encryption and decryption block corresponding to the addresses 0×20, 0×24, 0×28, 0×2c, 0×30, 0×34, 0×38 and 0×3c, the access address information AI further includes the verification information block address VADD1. For the encryption and decryption block corresponding to the addresses 0x40, 0x44, 0×48, 0x4c, 0x50, 0x54, 0x58 and 0x5c, the access address information AI further includes the verification information block address VADD2. The content of each of the verification information block address VADD1 and the verification information block address VADD2 includes the sum of the initial address and the corresponding offset. The actual address range requested by the processor 130 is also illustrated in a thick frame in FIG. 6D.

As a result, according to the different access forms and different access ranges of the access command AC generated by the processor 130 in FIG. 1, the memory access circuit 140 in FIG. 3 may perform different access methods.

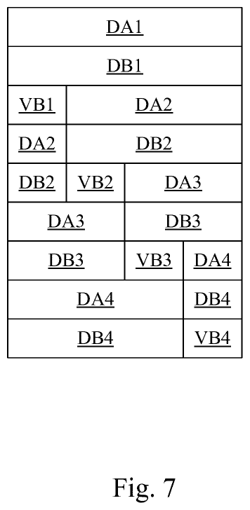

Reference is now made to FIG. 7. FIG. 7 illustrates the memory area AR2 in FIG. 2 according to another embodiment of the present invention.

Similar to FIG. 2, the memory area AR2 in FIG. 7 includes the data blocks DA1˜DA4 and DB1˜DB4 and the verification information blocks VB1˜VB4. However, in the present embodiment, each of the verification information blocks VB1˜VB4 is disposed subsequent to the corresponding data blocks DA1˜DA4 and DB1˜DB4.

More specifically, the verification information block VB1 is disposed subsequent to the data blocks DA1 and DB1. The verification information block VB2 is disposed subsequent to the data blocks DA2 and DB2. The verification information block VB3 is disposed subsequent to the data blocks DA3 and DB3. The verification information block VB4 is disposed subsequent to the data blocks DA4 and DB4.

Under such a condition, the addresses of the data blocks DA1˜DA4 and DB1˜DB4 are not continuous. An address offset exists between each of two corresponding data blocks, in which the address offset equals to the size of the corresponding verification information block. For example, the addresses between the data blocks DA1 and DB1 and the data blocks DA2 and DB2 are not continuous due to the existence of the verification information block VB1. An address offset equaling to the size of the verification information block VB1 exists.

Under such a condition, the address generation circuit 320 in FIG. 3 calculates and generates the data block address and the verification information block address included by the access block address AD according to the access address information AI, the mode information MI and address offset. The command generation circuit 330 further generates the actual access command RC according to the access block address AD to access the flash memory 120.

As a result, based on different configurations of the memory blocks in the flash memory 120, the memory access circuit 140 in FIG. 3 may perform different access methods.

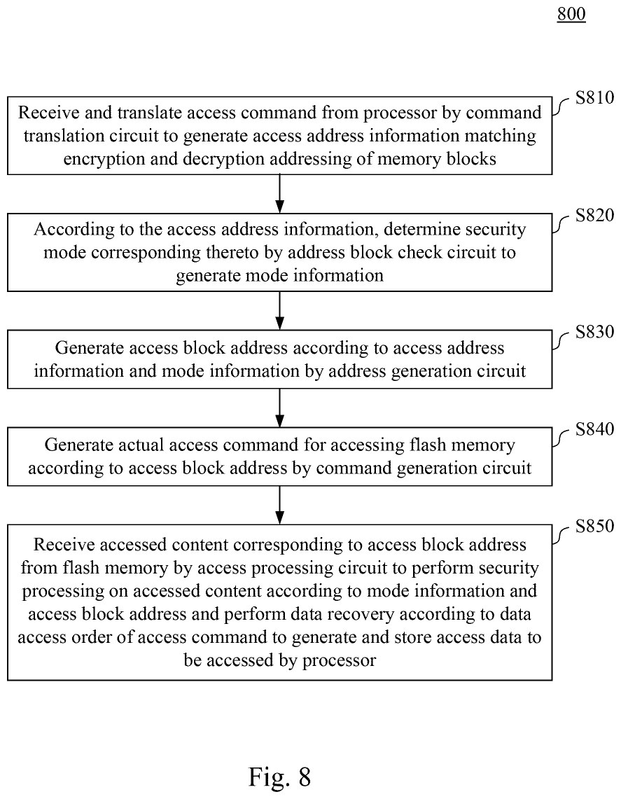

Reference is now made to FIG. 8. FIG. 8 illustrates a flow chart of a memory access method 800 according to an embodiment of the present invention.

In addition to the apparatus described above, the present disclosure further provides the memory access method 800 having a secure access mechanism that can be used in such as, but not limited to, the memory access circuit 140 in FIG. 3. As illustrated in FIG. 8, an embodiment of the memory access method 800 includes the following steps.

In step S810, the access command AC is received and translated from the processor 130 by the command translation circuit 300 to generate the access address information AI matching the encryption and decryption addressing of the memory blocks.

In step S820, according to the access address information AI, the security mode corresponding thereto is determined by the address block check circuit 310 to generate the mode information MI.

In step S830, the access block address AD is generated according to the access address information AI and the mode information MI by the address generation circuit 320.

In step S840, the actual access command RC for accessing the flash memory 120 is generated according to the access block address AD by the command generation circuit 330.

In step S850, the accessed content CO corresponding to the access block address AD is received from the flash memory 120 by the access processing circuit 340 to perform the security processing on the accessed content CO according to the mode information MI and the access block address AD and perform the data recovery according to the data access order of the access command AC to generate and store access data DD to be accessed by the processor 130.

It is appreciated that the embodiments described above are merely an example. In other embodiments, it should be appreciated that many modifications and changes may be made by those of ordinary skill in the art without departing, from the spirit of the disclosure.

In summary, the present invention discloses the memory access circuit and the memory access method having secure access mechanism that respectively perform processing on memory areas in a flash memory having different security modes and perform security processing on respectively memory blocks in the flash memory without loading the whole image file. The memory access circuit can thus decrease the cost of the security processing and accomplish the XiP application for the system-on-a-chip that the memory access circuit resides.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A memory access circuit having a secure access mechanism configured to access a flash memory, wherein the flash memory comprises a plurality of memory blocks categorized into a plurality of memory areas each configured to have a security mode, the memory access circuit comprising:
a command translation circuit configured to receive and translate an access command from a processor to generate access address information matching an encryption and decryption addressing of the memory blocks;
an address block check circuit configured to, according to the access address information, determine the security mode corresponding thereto to generate mode information;
an address generation circuit configured to generate an access block address according to the access address information and the mode information;
a command generation circuit configured to generate an actual access command for accessing the flash memory according to the access block address; and
an access processing circuit configured to receive an accessed content corresponding to the access block address from the flash memory to perform a security processing on the accessed content according to the mode information and the access block address and perform a data recovery according to a data access order of the access command to generate and store access data to be accessed by the processor.

2. The memory access circuit of claim 1, wherein when the mode information indicates that the security mode is a non-encrypted and non-verification mode, the access processing circuit performs the security processing that comprises a bypass process.

3. The memory access circuit of claim 1, wherein when the mode information indicates that the security mode is an encryption mode, the access processing circuit performs the security processing that comprises a decryption process on the accessed content, and the decryption process decrypts the accessed content according to encryption and decryption information related to the access block address.

4. The memory access circuit of claim 3, wherein the encryption and decryption information comprises an initial vector (IV) that comprises a nonce section, a block address section, a reserved section, a block offset section or a combination thereof.

5. The memory access circuit of claim 1, wherein when the mode information indicates that the security mode is a verification mode, the address generation circuit generates the access block address that comprises at least one data block address and at least one verification information block address such that the access processing circuit performs the security processing that comprises a verification process on the accessed content, the accessed content comprises a data content and a verification information content and the verification process is configured to perform verification on the data content according to the verification information content; and
when the mode information indicates that the security mode is an encrypted and verification mode, the access processing circuit generates the access block address that comprises the at least one data block address and the at least one verification information block address such that the access processing circuit performs the security processing that comprises a decryption process and the verification process on the accessed content, the accessed content comprises the data content and the verification information content, wherein:
the decryption process is configured to perform decryption on the accessed content according to encryption and decryption information related to the access block address; and
the verification process is configured to perform verification on the data content according to the verification information content.

6. The memory access circuit of claim 5, wherein the plurality of memory blocks comprise a plurality of data blocks and a plurality of verification information blocks, wherein the verification information content stored in each of the verification information blocks is generated correspondingly by performing calculation on an encryption and decryption block that comprises 2N of the data blocks, N being an integer larger than or equaling to 0.

7. The memory access circuit of claim 6, wherein the plurality of data blocks and the plurality of verification information blocks are disposed independently, the address generation circuit generates the data block address according to the access address information and calculates the verification information block address according to the data block address.

8. The memory access circuit of claim 6, wherein each of the plurality of verification information blocks is disposed subsequently to the corresponding encryption and decryption block such that an address offset exists between each of two neighboring encryption and decryption blocks, such that the address generation circuit calculates and generates the data block address and the verification information block address according to the access address information, the mode information and the address offset.

9. The memory access circuit of claim 1, further comprising a storage circuit configured to store the access data, a verification state of the access data and a data address of the access data for the processor to access the access data when the verification state indicates to be a verified state;
wherein when the access address information generated according to a subsequent access command that the command translation circuit receives and translates from the processor corresponds to the data address and the verification state indicates to be a verified state, the access data is directly accessed by the processor from the storage circuit.

10. The memory access circuit of claim 1, wherein the command generation circuit transmits the actual access command to the flash memory to perform accessing through an interface control circuit configured to perform a format conversion, and the access processing circuit receives the accessed content from the flash memory through the interface control circuit configured to perform the format conversion.

11. A memory access method having a secure access mechanism used in a memory access circuit configured to access a flash memory, wherein the flash memory comprises a plurality of memory blocks categorized into a plurality of memory areas each configured to have a security mode, the memory access method comprising:
receiving and translating an access command from a processor by a command translation circuit to generate access address information matching an encryption and decryption addressing of the memory blocks;
according to the access address information, determining the security mode corresponding thereto by an address block check circuit to generate mode information;
generating an access block address according to the access address information and the mode information by an address generation circuit;
generating an actual access command for accessing the flash memory according to the access block address by a command generation circuit; and
receiving an accessed content corresponding to the access block address from the flash memory by an access processing circuit to perform a security processing on the accessed content according to the mode information and the access block address and perform a data recovery according to a data access order of the access command to generate and store access data to be accessed by the processor.

12. The memory access method of claim 11, wherein when the mode information indicates that the security mode is a non-encrypted and non-verification mode, the memory access method further comprises:
performing the security processing that comprises a bypass process by the access processing circuit.

13. The memory access method of claim 11, wherein when the mode information indicates that the security mode is an encryption mode, the memory access method further comprises:
performing the security processing that comprises a decryption process on the accessed content by the access processing circuit, and the decryption process decrypts the accessed content according to encryption and decryption information related to the access block address.

14. The memory access method of claim 13, wherein the encryption and decryption information comprises an initial vector that comprises a nonce section, a block address section, a reserved section, a block offset section or a combination thereof.

15. The memory access method of claim 11, further comprising:
when the mode information indicates that the security mode is a verification mode:
generating the access block address that comprises at least one data block address and at least one verification information block address by the address generation circuit; and
performing the security processing that comprises a verification process on the accessed content by the access processing circuit, the accessed content comprising a data content and a verification information content and the verification process being configured to perform verification on the data content according to the verification information content; and
when the mode information indicates the security mode is an encrypted and verification mode:
generating the access block address that comprises the at least one data block address and the at least one verification information block address by the access processing circuit; and
performing the security processing that comprises a decryption process and the verification process on the accessed content by the access processing circuit, the accessed content comprising the data content and the verification information content, wherein:
the decryption process is configured to perform decryption on the accessed content according to encryption and decryption information related to the access block address; and
the verification process is configured to perform verification on the data content according to the verification information content.

16. The memory access method of claim 15, wherein the plurality of memory blocks comprise a plurality of data blocks and a plurality of verification information blocks, wherein the verification information content stored in each of the verification information blocks is generated correspondingly by performing calculation on an encryption and decryption block that comprises 2N of the data blocks, N being an integer larger than or equaling to 0.

17. The memory access method of claim 16, wherein the plurality of data blocks and the plurality of verification information blocks are disposed independently, the memory access method further comprising:
generating the data block address according to the access address information and calculating the verification information block address according to the data block address by the address generation circuit.

18. The memory access method of claim 16, wherein each of the plurality of verification information blocks is disposed subsequently to the corresponding encryption and decryption block such that an address offset exists between each of two neighboring encryption and decryption blocks, the memory access method further comprising:
calculating and generating the data block address and the verification information block address according to the access address information, the mode information and the address offset by the address generation circuit.

19. The memory access method of claim 11, further comprising:
storing the access data, a verification state of the access data and a data address of the access data for the processor to access the access data by a storage circuit when the verification state indicates to be a verified state; and
when the access address information generated according to a subsequent access command that the command translation circuit receives and translates from the processor corresponds to the data address and the verification state indicates to be a verified state, directly accessing the access data by the processor from the storage circuit.

20. The memory access method of claim 11, further comprising:
transmitting the actual access command to the flash memory by the command generation circuit to perform accessing through an interface control circuit configured to perform a format conversion; and
receiving the accessed content from the flash memory by the access processing circuit through the interface control circuit configured to perform the format conversion.
